(19) United States
(12) Patent Application Publication
(10) Pub. No.: US 2022/0017798 A1
(43) Pub. Date: Jan. 20, 2022

(54) COMPLEX POLYCRYSTALLINE DIAMOND COMPACT

(71) Applicant: SF Diamond USA, INC., Spring, TX (US)

(72) Inventors: Fang Haijiang, Zhengzhou (CN); Du Weifeng, Zhengzhou (CN)

(21) Appl. No.: 16/930,946

(22) Filed: Jul. 16, 2020

(51) Int. Cl. C09K 3/14; B23B 27/14

(52) U.S. Cl. CPC C09K 3/14; B23B 2226/315; B23B 27/148

(57) ABSTRACT

A new type of polycrystalline diamond composite drill bit insert comprising a polycrystalline diamond layer and a cemented carbide matrix; the polycrystalline diamond having a top surface formed at two different heights. The polycrystalline diamond composite comprises at least one upper surface that is higher than the top surface of the primary layer of the polycrystalline diamond composite; where the primary layer forms an interface with the cemented carbide insert and the upper layer is formed on, or above, the primary layer. The cutting profile, or cutting area, of the upper layer is reduced from the cutting profile of the primary layer. The surface shape or area of the upper polycrystalline diamond is different from that of the lower primary surface layer and can form more than one vertex. The variable surface heights, and the reduced cutting profile of the upper layer of polycrystalline diamond composite, allows for the insert to cut or plough through rock or concrete more easily and efficiently, than a conventional, single layer polycrystalline diamond compact.

### BACKGROUND

A PDC or, more specifically, a Polycrystalline diamond compact, generally includes a planer wear-resistant diamond layer on the upper surface of a cemented carbide matrix body or substrate formed as cylinder. The diamond layer is bonded to the body under a combination of high temperature and high pressure. The PDC stud is directly welded into a hole or receiver formed in the drill body by brazing, or the PDC can also be inserted into the receiver in the drill body by press-fitting to form a PDC drill.

In order to form a PDC, the manufacturer generally places a mixture of tungsten carbide and metal binder into a cylindrical container with diamond powder mixed with a metal binder on the upper surface of the cemented carbide substrate to form a polycrystalline diamond composite table. The assembled container is placed in a high-temperature and high-pressure press and, in the presence of a catalyst, the body substrate and the polycrystalline diamond layer are bonded together through a sintering process.

With the innovative development of exploration concepts, unconventional oil and gas exploration has achieved rapid development. The design of drill bits and the performance of PDC for deep and complicated formations need to be continuously improved, especially for difficult to drill formations such as when the rock is extremely hard, or extremely plastic and where drilling conditions are often difficult due to poor cutting circulation and insufficient cooling. These and other drilling problems can cause low drilling efficiency or a low rate of penetration (ROP), rapid wear of the polycrystalline diamond table and shorten the overall life of the drill bit.

The invention of the present application proposes a new type polycrystalline diamond composite, which includes a polycrystalline diamond layer or table and a hard alloy substrate; the polycrystalline diamond table containing at least two layers forming surfaces of different heights and there being at least one polycrystalline diamond surface of the table with a different height between the highest surface of the upper surface of the layer forming an interface between polycrystalline diamond and the cemented carbide substrate. For any two adjacent surfaces, the surface shape, or area of, the upper polycrystalline diamond layer, is different from that of the lower surface, and can form more than one geometric vertex; wherein the geometric vertex is defined as the points on the perimeter of the surface which are farthest from the geometric center of the surface, such as, the points of a diamond, the corners of a square, the points of a triangle or the points, or petals, on a rosette shape. It is maintained that a vertex can be defined as the highest point on a parabola, such as, the apex of the curve of an oval, and additionally it can be argued that a circle has an infinite series of vertices around the perimeter.

As the polycrystalline diamond compact of the present invention has at least two different surfaces for cutting; different cutting depths are formed when cutting a rock formation or concrete. The dual cutting surfaces allow the PDC to more easily penetrate and plough through rock formations, or concrete, on both the initial cutting pass, and during additional passes made by reciprocal PDC as the drill bit advances. Additionally, due to the point contact, line contact and surface contact of the new and novel design, the polycrystalline diamond composites resistance to breakage is improved, along with the overall life of the PDC. The use of the new polycrystalline diamond compact of the present invention can achieve the purpose of improving drilling efficiency and extending the life of the drill bit.

### SUMMARY OF THE INVENTION

The object of the present invention is to provide a new type of polycrystalline diamond composite table by changing the shape and structure of the upper surface and outer edge surface of the polycrystalline diamond layer of the PDC. This PDC can be used in extremely hard, plastic and other difficult to drill formations, overcoming problems such as difficulty in cutting, slow rate of penetration, slow rotational machine speed, and low efficiency; all while improving overall drilling efficiency and reducing costs.

One embodiment of the present invention discloses a new type polycrystalline diamond composite, which comprises a polycrystalline diamond table and a hard alloy matrix substrate; the polycrystalline diamond layer containing at least two surfaces of different heights. Between the highest surface of the poly crystalline diamond table and the cemented carbide substrate, there is at least another second surface with a different height, so that different cutting depths can be formed in the rock during cutting.

In another embodiment of the present invention, the novel polycrystalline diamond composite is characterized in that each top surface of the polycrystalline diamond formed with different cutting depths may be a planar structure.

In yet another embodiment of the present invention, the novel polycrystalline diamond composite is characterized in that each surface of the polycrystalline diamond formed with different cutting depths may have a non-planar structure.

Further, in yet another embodiment, the novel polycrystalline diamond composite is characterized in that the surfaces of the structure can be different shapes, such as an arcuate shape or an irregular shape.

In yet another embodiment, the novel polycrystalline diamond composite is characterized in that the non-planar structure may be a plurality of small protrusions, or a plurality of large protrusions or a combination thereof.

The disclosure of the present invention relates to a new type of polycrystalline diamond composite drill bit insert comprising a polycrystalline diamond layer and a cemented carbide substrate; the polycrystalline diamond having a top surface formed with, at least, two different heights. In the present invention the polycrystalline diamond composite comprises at least one upper surface that is higher than the top surface of the primary layer of the polycrystalline diamond composite; where the primary layer forms an interface with the cemented carbide insert and the upper layer is formed on, or above, the primary layer. The cutting profile, or cutting area, of the upper layer is reduced from the cutting profile of the primary layer. The surface shape or area of the upper polycrystalline diamond is different from that of the lower primary surface layer and can form more than one vertex. The variable surface heights, and the reduced cutting profile of the upper layer of polycrystalline diamond composite allows for the insert to cut or plough through rock or concrete more efficiently than a conventional, single layer polycrystalline diamond compact.

### BRIEF DESCRIPTION OF DRAWINGS

The following description of the embodiments can be understood in light of the Figures, which illustrate specific aspects of the embodiments and are part of the specification. Together with the following description, the Figures demonstrate and explain the principles of the embodiments.

FIGS. 1 through 13 are perspective views of a PDC having a multi-layer polycrystalline diamond composite table, and,

FIG. 14 is a sectional view of a PDC cutting path.

### DETAILED DESCRIPTION OF THE DRAWINGS

The following description of the embodiments can be understood in light of the Figures which illustrate specific aspects of the embodiments and are part of the specification. Together with the following description, the Figures demonstrate and explain the principles of the embodiments. In the Figures the physical dimensions of the embodiment may be exaggerated for clarity. The same reference numerals or word descriptions in different drawings represent the same element, and thus their descriptions may be omitted.

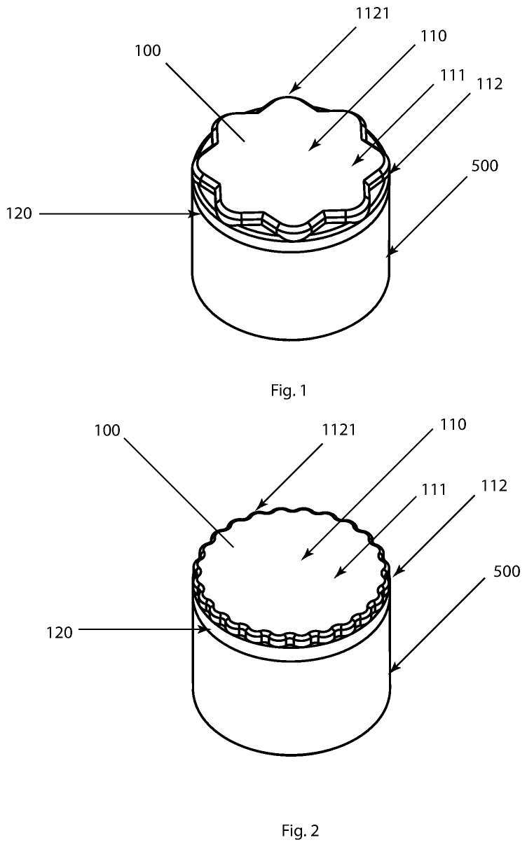

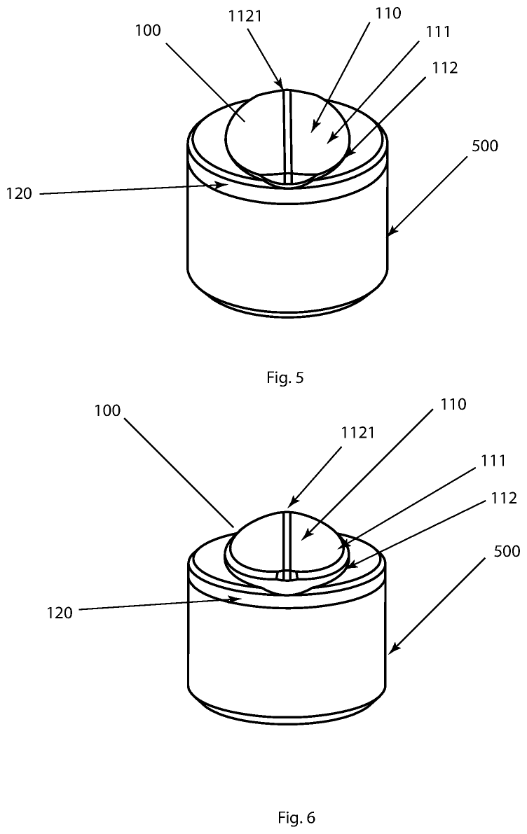

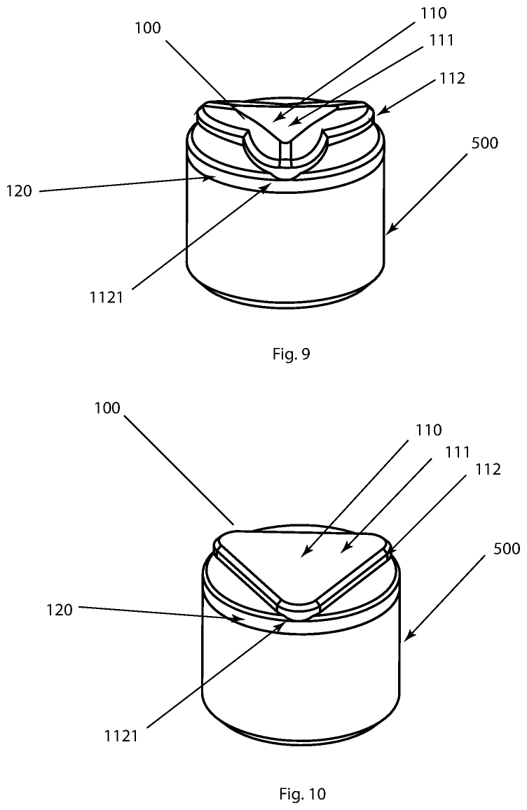

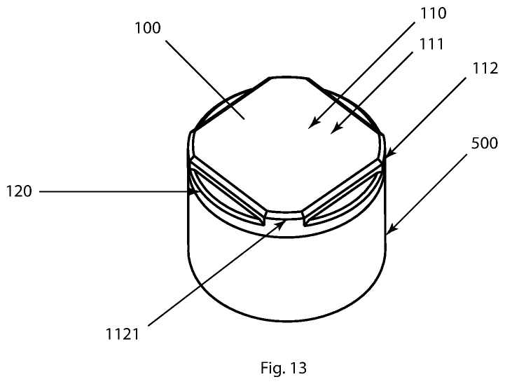

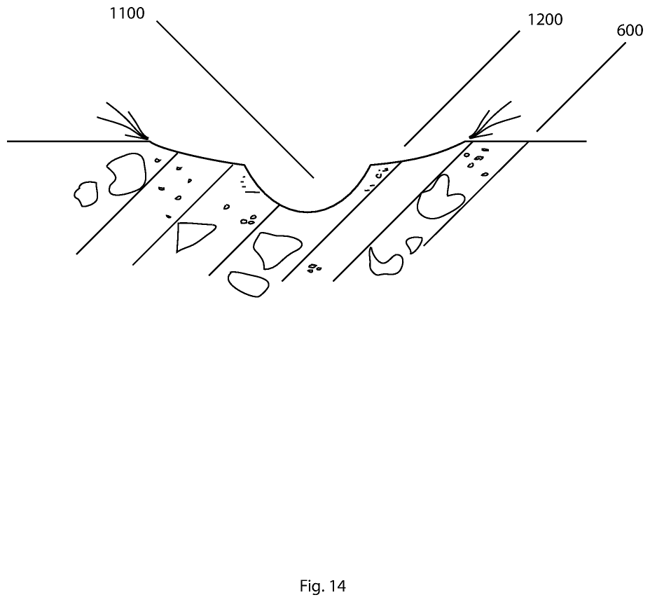

A first embodiment of the present invention or Complex Polycrystalline Diamond Compact (PDC), FIGS. 1 through 13, comprising a polycrystalline diamond composite table 100, the table having a upper layer 110 and a lower layer 120 bonded to a tungsten carbide substrate 500 forming the overall shape of cylinder having a circular cross-section. In other embodiments the PDC may be formed having an oval, square, rectangular, triangular or another irregular shaped cross-section. The upper layer 110 of the polycrystalline diamond table 100 having an upper surface 111 and a cutting edge 112; the cutting edge 112, forming at least one vertex 1121, or a plurality of vertices. The lower layer 120 also have a cutting edge 121 including at least one vertex or if formed as circular shape, the cutting edge 121 having an infinite number of vertices. The upper surface 111 having a different height than the surface of the lower polycrystalline diamond layer 120 and the upper layer 110 having a smaller overall surface area than the theoretical surface area of the lower layer 120 and the upper layer 110 may have the same shape as the lower layer 120 or the upper layer 110 may have a different shape than the lower layer 120. The measurement for the radius of the lower layer 120 is equal to, or greater than the measurement for the any vertex 1121 formed on the cutting edge 112 of the upper layer 110

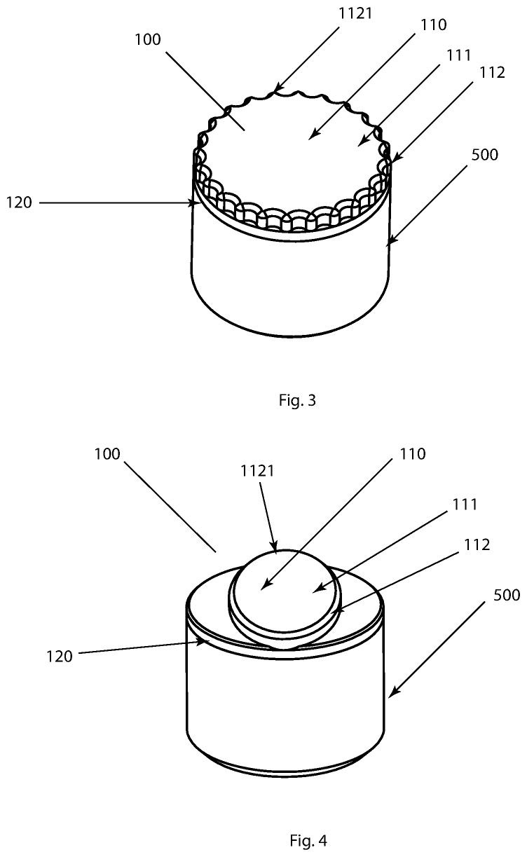

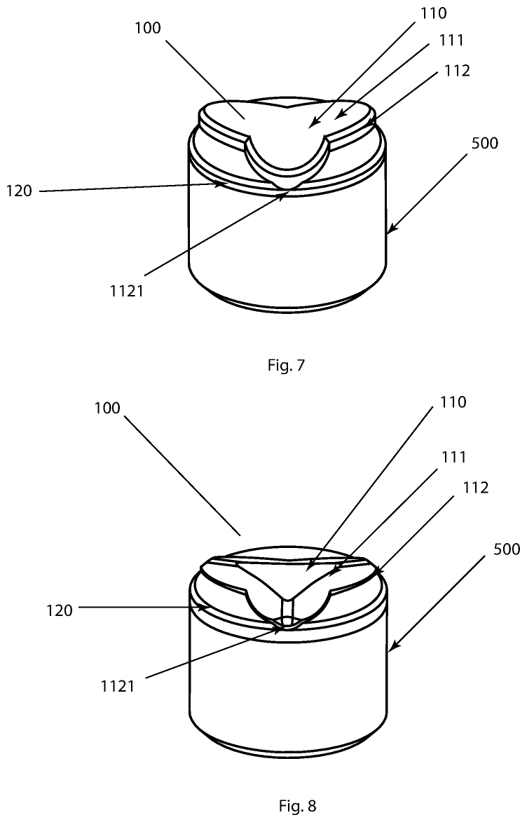

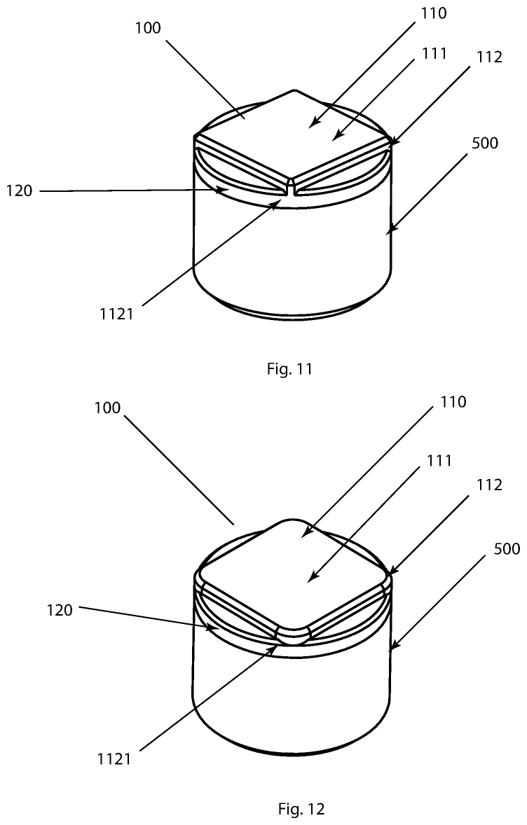

The cutting edge of 112 of the upper layer 110 can be configured to provide a plurality of profiles in order to optimize cutting and ploughing efficiency of the drill bit and may be selected due to type of ground or rock formations, the hardness or the elasticity of rock formation. The cutting edge 112 of each of FIGS. 1 through 3 can be described as rosette patterns, with FIGS. 1 and 3 forming a pattern with a plurality of lobes or vertices 1121, whereas, the embodiment of FIG. 3 the cutting edge 112 has a scalloped pattern forming a plurality of scoops and teeth and each tooth defined as a vertex 1121. The embodiments of FIGS. 4 through 6 having an upper layer 110 having an upper surface 111 forming an oval with a smooth cutting edge 112 and vertex 1121. In some embodiments the upper surface 111 may be substantially planer, or may be crowned, or rounded forming, an arcuate shape, or may be a tented shaped having two or more planer surfaces that meet proximate a centerline. The embodiments of FIGS. 7 through 9 have smooth cutting edges 112 and modified triangular upper surfaces 111. It is contemplated that triangular upper surfaces 111 will provide improved wear performance and sustained cutting performance after significant wear due to a reduced cutting profile after significant wear. FIGS. 10 through 13 provide an upper surface profile having clear geometric shapes, FIG. 10 having a triangular upper layer 110 and FIGS. 11 through 13 having a substantially square or rectangular upper layer 110. The cutting edges 112 may form a face which is entirely perpendicular to the upper surface 111 or cutting edge 112 may include a round over or a chamfered edge.

FIG. 14 as shown describes a rock or concrete material cutting profile formed by the polycrystalline diamond compact of the present invention. As shown the surface penetration into rock 600 includes two distinct areas, a central gouge 1100 formed by the top layer 110 of the diamond composite and peripheral gouges 1200 formed by the lower layer 120 of the composite. While the dimensions described in FIG. 14 are exaggerated to better demonstrate the cutting profile and capacity of a PDC having two distinct cutting layers, the cutting profile shown in FIG. 14 is an accurate representation for a cutter such as one shown in FIGS. 4 through 6. As shown, the smaller profile of the upper layer 110 of the PDC of present invention will require less drill energy in order to create a deeper preliminary cut. The preliminary cut will be continue to be hogged out and deepened by additional passes from the initial PDC cutter 100 or will cut deeper by reciprocal PDC cutters as the drill bit advances in the bore hole.

It is to be understood that the above mentioned arrangements are only illustrative of the application of the principles of the present disclosure. Numerous modifications or alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

1. A polycrystalline diamond composite comprising;
a tungsten carbide substrate formed as a cylinder,
the cylinder having a central axis,
the cylinder having a top surface,
a polycrystalline diamond table formed on the top surface of the substrate,
the table having,
a lower layer,
the lower layer having a cutting edge,
the lower layer having at least one vertex on the cutting edge,
an at least one upper layer,
the upper layer having a cutting edge,
the upper layer having at least one vertex on the cutting edge,
the upper layer having an upper surface,
the upper layer having a first height,
the lower layer having a second height different than the first height of the upper layer, and,
the measurement from the central axis to the vertex of the upper layer is less than, or equal to, the measurement from the central axis to the vertex of the lower layer.

2. The composite of claim 1 wherein the upper surface of the upper layer is planer.

3. The composite of claim 1 wherein the upper surface of the upper layer forms an arcuate shape.

4. The composite of claim 3 where the arcuate shape forms a central vertex.

5. The composite of claim 3 where the arcuate shape form a vertex that offset from the central axis.

6. The composite of claim 1 wherein the upper surface of the upper layer includes two or more inclined planer surfaces which meet along a common central axis.

7. The composite of claim 1 wherein the upper surface of the upper layer is non-planer.

8. The composite of claim 1 wherein cutting edge of the upper layer includes a plurality of vertices.

9. The composite of claim 1 wherein cutting edge of the upper layer includes a plurality of protrusions.

10. The composite of claim 1 wherein cutting edge of the upper layer includes a plurality of flutes.

11. The composite of claim 10 wherein in the plurality of flute form a plurality of reciprocal vertices.

12. The composite of claim 1 wherein the area of the upper surface forms a rosette shape.

13. The composite of claim 1 wherein the area of the upper surface forms a geometric shape.

13. The composite of claim 12 wherein the geometric shape is one of a circle, oval, triangle, square and rectangle.

14. The composite of claim 1 wherein the area of the upper surface forms an irregular shape.
